(19) United States
(12) Patent Application Publication
(10) Pub. No.: US 2023/0188504 A1
(43) Pub. Date: Jun. 15, 2023

(54) CURATING SERVICES THROUGH PROXIES WITH EXTENSIBLE POLICY

(71) Applicant: Microsoft Technology Licensing, LLC, Redmond, WA (US)

(72) Inventor: Stephen Wharton PROVINE, Bellevue, WA (US)

(21) Appl. No.: 17/551,529

(22) Filed: Dec. 15, 2021

(51) Int. Cl. H04L 9/40

(52) U.S. Cl. CPC H04L 63/0281; H04L 63/20; H04L 63/1416; H04L 63/145

(57) ABSTRACT

Techniques for operating a proxy service that imports information about resources and for determining how to handle the resources are disclosed. Policy is used to configure the proxy service, which is provisioned to operate between a client and a provider service. A request is then received (e.g., from the client) for a resource that is available from the provider service. In response to the request, the proxy service imports claims describing the resource. The proxy service evaluates the claims using the policy to determine how to respond to the request. Based on the evaluation, the proxy service provides a response to the client.

### BACKGROUND

Computers are often subject to numerous different types of attacks (i.e. cyber-attacks). By way of example, these attacks include malware attacks, phishing attacks, denial of service (DOS) attacks, and so on. Indeed, there is almost an unlimited number of different ways for a computer system to be attacked and/or hacked by a malicious entity.

Protecting against such attacks is an ever ongoing operation. There are various different ways to protect a computer. Such ways include, but certainly are not limited to, provisioning a so-called “firewall” for a computer system as well as provisioning an “antivirus” package for the system. FIGS. 1A and 1B illustrate a firewall and an antivirus, respectively.

FIG. 1A shows an enterprise environment 100 that includes an example device 105. Here, a server 110 is communicating with the device 105 via a network 115. In order to safeguard the device 105 from various threats, the current technology allows for a firewall 120 to be provisioned in the enterprise environment 100.

The firewall 120 is a type of software (or potentially hardware device) that monitors the channels through which data packages are flowing as well as the various protocols that are being used. In some instances, the firewall 120 can perform some simplified packet scanning operations. Scanning the channels and the packets is performed in an attempt to identify attacks and/or malicious data and even to regulate network traffic. The firewall 120 can perform packet filtering and packet state inspection. Packet filtering is a type of simplified, brute-force effort where packet characteristics are identified and then compared against a group of filters. The filters operate on the packets to remove known threats. Packet state inspection generally involves examining a packet's headers to determine whether the packet originated from a trusted source. If a packet is determined to be a risk, then the firewall 120 will flag the packet and prevent it from reaching the device 105.

FIG. 1B shows a device 125 (e.g., a client device) communicating with a server 130 over a network 135. Device 125 has installed (locally) antivirus 140 software. The antivirus 140 software is a type of software that scans, detects, and removes viruses from the device 125. Typically, the antivirus 140 software runs automatically in the background of the device 125 and scans files as they are stored or downloaded onto the device 125.

As evidenced above, there are numerous different types of techniques for protecting a computer. Despite the availability of these techniques, there is still a serious need for additional and enhanced protection techniques. What is needed, therefore, is a technique that provides further protections beyond those that are provided by traditional techniques, including firewalls and antivirus software.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices, and methods for operating a proxy service that imports information about one or more resources and for determining how to handle the resources.

For instance, some embodiments use policy to configure the proxy service, which is provisioned to operate between a client and a provider service. A request is then received (e.g., from the client) for a resource that is available from the provider service. In response to the request, the proxy service imports one or more claims describing the resource. The proxy service then performs an evaluation on the claims using the policy to determine how to respond to the request received from the client. Based on the evaluation, a response is provided to the client.

Some embodiments use policy to configure the proxy service, which is provisioned to operate between a client and a provider service. The embodiments also receive, from the client, a request for a resource that is available from the provider service. In response to the request, the proxy service imports one or more claims describing the resource. The proxy service also performs an evaluation on the claims using the policy to determine how to respond to the request. A response is generated based on a result of the evaluation. Notably, the response can include various pieces of information, such as (i) the resource, or (ii) a denial indicating that the resource will not be delivered to the client, or (iii) an indication that the resource is being held in quarantine, or (iv) a qualified version of the resource. In some cases, the response will include the resource and information regarding why it should possibly be avoided. In some cases, the response will not include the resource, but it can include information detailing why the resource was denied. Here, the qualified version of the resource includes the resource and one or more indicators describing a status of the resource. The embodiments also cause the proxy service to digitally sign the response and to then provide the digitally signed response to the client.

Some embodiments use policy to configure a proxy service. The proxy service is upstream of a client, and a provider service is upstream of the proxy service. The embodiments receive a request for a resource that is available from the provider service. In response to the request, the proxy service imports claims describing the resource. An evaluation is performed on the claims using the policy. The proxy service generates a response based on a result of the evaluation, where this response includes a curated version of the resource. The curated version includes supplemental information about the resource. In some cases, the resource itself can be modified (e.g., curated). That is, it may be the case that supplemental information can be added to the resource, but it may also be the case that the resource itself is modified in some manner beyond just appending additional information to it. Such modifications can include changes perhaps to underlying code, metadata, and so forth. The embodiments then provide the response to the client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIGS. 1A and 1B illustrate various techniques for safeguarding a computer against various threats.

FIG. 2 illustrates an improved architecture in which a proxy service is provisioned upstream of a client and downstream of a provider service.

FIG. 3 illustrates an alternative configuration for the proxy service.

FIG. 4 illustrates various examples of different types of resources that a provider service can provide.

FIG. 5 illustrates different types of metadata that can be used to evaluate a resource.

FIG. 6 illustrates some additional evidence that can be included in a claim describing a resource.

FIG. 7 illustrates another example architecture in which a proxy service performs various operations to evaluate a resource.

FIG. 8 illustrates various policies that can be implemented by the proxy service.

FIG. 9 illustrates various pieces of information that can be included in a response, which is provided by the proxy service and which is provided to the client.

FIG. 10 illustrates different types of information that can be included in a response.

FIG. 11 illustrates a flowchart of an example method describing operations performed by the proxy service.

FIG. 12 illustrates another flowchart of an example method describing various operations performed by the proxy service.

FIG. 13 illustrates yet another flowchart of an example method describing various operations performed by the proxy service.

FIG. 14 illustrates an example computer system that can be configured to perform any of the disclosed operations.

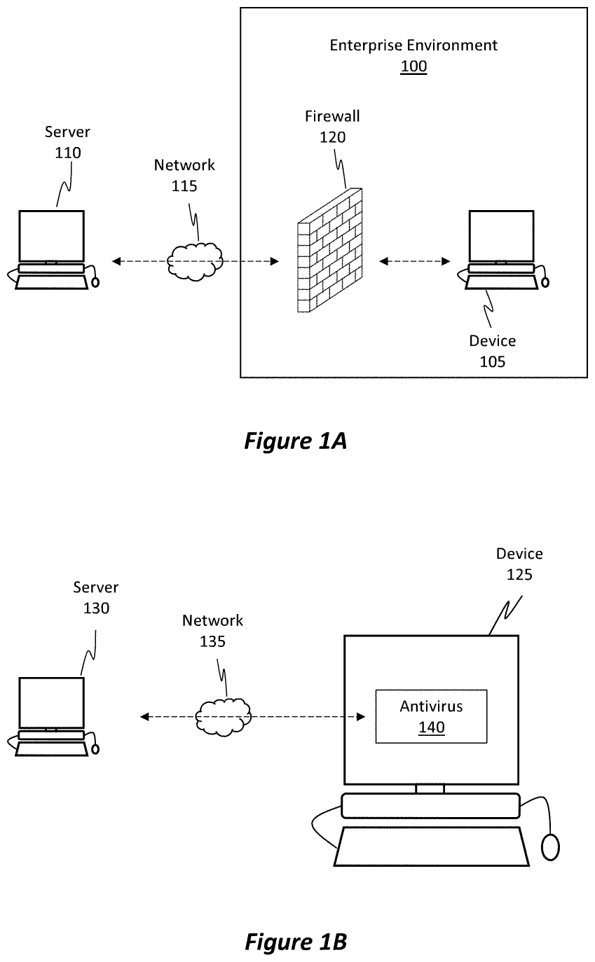

### DETAILED DESCRIPTION

Embodiments disclosed herein relate to systems, devices, and methods for operating a proxy service that imports information about resources and for determining how to handle the resources.

Policy is used to configure a proxy service, which is provisioned to operate between a client and a provider service. The proxy service receives a request from the client for a resource. The proxy service imports claims describing the resource. The proxy service evaluates the claims using the policy to determine how to respond to the request. Based on the evaluation, the proxy service provides a response to the client.

In some embodiments, policy is used to configure the proxy service. The proxy service receives a request for a resource. In response to the request, the proxy service imports claims describing the resource and then evaluates those claims. For example, the proxy service can evaluate the claims using the policy that was previously received. The proxy service generates a response. The response includes the resource, or a denial indicating that the resource will not be delivered to the client, or an indication that the resource is being held in quarantine, or a qualified version of the resource. The proxy service digitally signs the response and then provides the digitally signed response to the client.

Some embodiments use policy to configure the proxy service. The proxy service receives a request for a resource. The proxy service then imports claims describing the resource and evaluates those claims. The proxy service generates a response based on a result of the evaluation, where this response includes a curated version of the resource. The curated version includes supplemental information, which is linked to the resource and which describes the resource. The proxy service then provides the response to the client.

### Examples Of Technical Benefits, Improvements, And Practical Applications

The following section outlines some example improvements and practical applications provided by the disclosed embodiments. It will be appreciated, however, that these are just examples only and that the embodiments are not limited to only these improvements.

The disclosed embodiments bring about numerous benefits, improvements, and practical applications to the technical field. For instance, it is often the case that program developers reuse code from globally available open source repositories. Reusing code that has already been developed enables the programmer to spend his/her time developing new routines as opposed to “reinventing the wheel.” One drawback, however, with open source code is that some malicious actors may tamper with good code or may provide bad code. The disclosed embodiments enable client-side operators, such as code developers, to define and configure policy and other security related regulations and to then impose that policy on code that might be imported.

It is often the case that open source repositories have their own policies and security measures in place. Unfortunately, it is also often the case that these policies satisfy only the “lowest common denominator” and may not be up to certain standards desired by program developers. By practicing the disclosed principles, client-side developers can define various policies and then have those polices implemented on code that is being imported. Therefore, regardless of whatever policies an open source repository may have, clients can implement their own guidelines and policies to ensure that the code they are importing meets various security thresholds. While the above example was focused on software packages (i.e. a type of “resource”), one will appreciate that the imported “resource” can be any type of resource, as will be discussed in more detail later.

In this sense, the disclosed embodiments significantly improve computer security. The embodiments also improve a client's experience with a computer system by enabling a client to have enhanced control over the types of content and resources that are imported. Furthermore, the disclosed embodiment improve the efficiency of a computer via intelligent delegation of operations. That is, the described “proxy service” is designed in a manner to achieve maximum or at least enhanced computing efficiency by being configured to aggregate and compile certain information and to then make an evaluation based on that information. The embodiments delegate certain operations to other services to ensure that the proxy service operates in an optimally efficient manner.

The disclosed embodiments represent significant improvements over protections that might be provided by a firewall or an antivirus software. For instance, firewalls are often considered brute force techniques that operate on low-level communications or portals or network ports. Firewalls fail to provide in-depth and comprehensive analysis on a resource to determine whether it is safe or not. Similarly, antivirus software also fails to provide the heightened level of protections that the disclosed embodiments provide. Indeed, antivirus technology fails to import information from multiple different sources, some of which might be different than the source providing the resource, and to then analyze that information to determine whether the resource is safe in the same comprehensive manner that is currently being presented. The traditional technology also fails to import information on a potentially on-going basis (i.e. the disclosed embodiments can continuously or periodically import additional information as that information is acquired over time) in order to evaluate a resource.

Furthermore, the infrastructure or architecture of the disclosed proxy service is quite different than an antivirus architecture. Even further, antivirus technology is reactive in that it performs scans in response to data having already been downloaded onto a machine. The disclosed embodiments, on the other hand, are proactive and perform their analysis even before a resource is downloaded onto a machine. Accordingly, these and numerous other benefits and distinctions will now be described in more detail throughout the remaining portions of this disclosure.

### Improved Architecture For Provisioning A Proxy Service

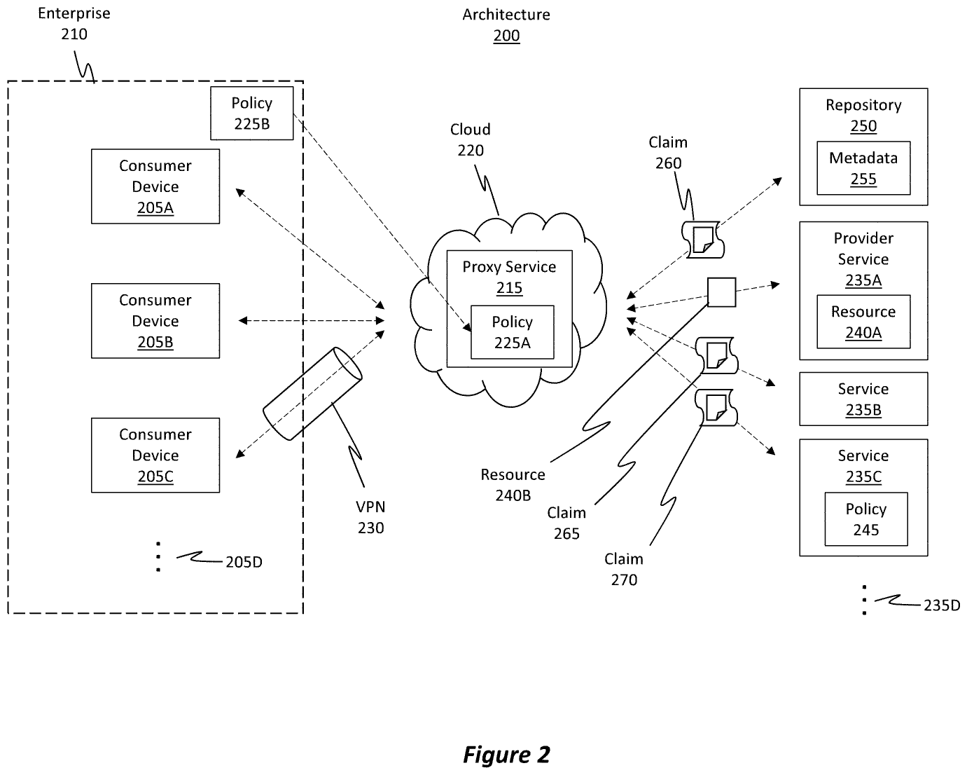

Attention will now be directed to FIG. 2, which illustrates an improved architecture 200 for analyzing resources that might be delivered to a client. Architecture 200 is shown as including a number of consumer devices, such as consumer device 205A, consumer device 205B, and consumer device 205C. The ellipsis 205D demonstrates how any number of consumer devices can be included in the architecture.

In some implementations, the consumer devices 205A-205C can be included as a part of an enterprise 210 or as a part of a group within the enterprise 210. That is, the enterprise 210 can include any number of groups of devices, and each group can be managed independently relative to any other group. In some cases, all of the groups are managed together.

In some implementations, the architecture 200 includes only a single consumer device, which can be separate and distinct from any other consumer device. An example of a consumer device can be a program developer or software engineer's device. Of course, other types of devices can be used as well.

As shown, the consumer devices can communicate (e.g., over a network) with a proxy service 215 that is optionally provisioned within a cloud 220 environment. The proxy service 215 can be considered a “reverse” proxy service. A reverse proxy is a type of proxy server or service that retrieves information and handles requests on behalf of a set of client devices. That is, the client devices communicate with the reverse proxy service, and then the reverse proxy service reaches out and communicates with other devices to handle requests submitted by the client devices. In this sense, requests are funneled from the client devices to the reverse proxy service, and the reverse proxy service then communicates with any number of external servers or devices to handle those requests. The reverse proxy service then returns a response to the client devices that submitted requests. As far as configuration is concerned, the reverse proxy service can be configured in a manner that is transparent to the client devices so that the client devices are not aware that they are not actually communicating with external servers but rather are communicating with an intermediary device.

The proxy service 215 is configured via policy 225A that is received from the client side of the architecture, as shown by policy 225B. That is, the clients of the consumer devices 205A-205C and/or the enterprise 210 itself can generate policy 225B and deliver that policy to the proxy service 215, as shown by policy 225A. In this sense, the operations of the proxy service 215 are governed by client-side policy as opposed to provider-side policy (e.g., a global repository might execute its own policies). As used herein, the term “client-side” should be interpreted broadly. For instance, “client-side” can refer to an “enterprise-wide” scenario or an “enterprise-configured” scenario. The term can also refer to a “consumer-side” scenario. To be clear, the term “client-side” should not be limited to scenarios where only a single client device is operating; instead, it can refer to scenarios where any number of devices are included within a group, such as an enterprise.

The consumer devices can communicate with the proxy service 215 in any manner. In some cases, a virtual private network VPN 230 can be configured between one or more consumer devices and the proxy service 215. In some cases, the proxy service 215 is within the local network of the enterprise 210 while in other cases the proxy service 215 resides outside of the enterprise network, as shown by the cloud 220 in FIG. 2.

As mentioned earlier, it is often the case that software engineers reuse code that has already been developed. These engineers can peruse a globally available repository where code resides and can select code to use for their own applications. The engineers can also reuse other resources that may be available from other external sources. Notably, the term “resource” should be interpreted broadly and can include any type of consumable data, not just coding data or software packages. Examples of resources will be provided later.

With the architecture 200, a consumer device (e.g., perhaps consumer device 205A) can determine that a particular resource is desired. In accordance with the disclosed principles, a request for a resource can be delivered to the proxy service 215 from the consumer device 205A. After receiving that request, the proxy service 215 is then triggered to query or search for that resource from any number of external sources, such as provider service 235A, service 235B, and service 235C. The ellipsis 235D indicates that any number of services can host or store the requested resource.

It should be noted that these external repositories, services, or sources can all execute their own respective security policies, as shown by service 235C executing policy 245 and as generally mentioned earlier. In some cases, the embodiments can be configured to chain proxy services together, potentially with ever-broadening policy being applied to those proxies. For example, in one scenario, it may be the case that the first proxy a client reaches might have the most constraining policy, while the next proxy it reaches might implement a division-wide policy (which is perhaps broader), and the next proxy it reaches might implement an organization-wide policy (which might be even more broad). This policy 245 is different than the policy 225A executed by the proxy service 215. Often, the policy 245 satisfies only the barest or simplest of safety measures whereas the policy 225A can be customized to any level of security threshold.

The proxy service 215 is able to communicate with any number of these sources in an effort to identify or find the requested resource. In this example scenario, the provider service 235A is currently storing the requested resource 240A.

The proxy service 215 is able to request the resource 240A or perhaps a certified copy of the resource 240A from the provider service 235A and/or from any number of other sources. In addition to obtaining the resource 240A, the disclosed proxy service 215 is able to obtain information describing various conditions, states, reputations, or statuses associated with the resource 240A. Using this additional information, the proxy service 215 can then determine whether or not the requested resource 240A satisfies the constraints outlined in the policy 225A.

In this sense, the embodiments not only analyze and evaluate the payload of the resource 240A itself (e.g., the underlying source code for a software package or perhaps the content of the files in a software package) but the embodiments also analyze and evaluate additional metadata or other data describing the resource 240A. The combination of the resource 240A as well as to supplemental metadata can enable the proxy service 215 to intelligently evaluate whether that resource 240A satisfies the security thresholds and constraints outlined by the policy 225A.

Often, the supplemental information is obtained from a source that is different than the source that provided the resource 240A. For instance, the proxy service 215 can communicate with a different source, such as repository 250, to obtain metadata 255 describing characteristics of the resource 240A, which is obtained from the provider service 235A. The metadata 255 can include any information describing the resource 240A. Examples of such metadata 255 can include, but certainly are not limited to, whether a malware scan or antivirus scan has been performed on the resource 240A, the author of the resource 240A, a timestamp indicating when the resource 240A was created and/or last modified, a location where the resource 240A resides, reputation data for an organization that created the resource 240A, usage data describing how well the resource 240A operates (e.g., perhaps data obtained from a forum describing the resource 240A and its usefulness or buggy features), and so on. Additional examples of metadata 255 will be provided later.

In any event, it is often the case that the metadata 255 is obtained from a source that is different than the source providing the resource. In some implementations, however, at least some of the metadata is obtained from the same source that provided the resource 240A. For instance, some of the metadata can be obtained from the provider service 235A.

FIG. 2 shows how the proxy service 215 is able to obtain the resource 240A from the provider service 235A, as shown by resource 240B. In addition to receiving that resource 240B, the proxy service 215 is able to query, ping, or request supplemental information about the resource 240A from any number of additional sources. This supplemental information is received in the form of a so-called “claim.” A “claim,” as used herein, refers to any supplemental or evidentiary information that is received from a source and that describes any type of characteristic related to a resource. That claim can include the metadata mentioned earlier as well as any other metadata or descriptive information.

FIG. 2 shows how the proxy service 215 is receiving a claim 260 from the repository 250. In addition to claim 260, the proxy service 215 is also receiving a claim 265 from service 235B and a claim 270 from service 235C. The proxy service 215 is aggregating and compiling these claims. While the claims are being collected, the proxy service 215 can evaluate the claims to determine whether the resource satisfies the policy 225A.

As an example, suppose one claim indicated that a malware scan produced three warnings regarding the safety of a particular resource. If the policy 225A dictated that a resource must have zero warnings associated with it, then the proxy service 215 can determine that this particular resource failed to satisfy the conditions outlined by the policy 225A.

As another example, the policy 225A might dictate that an author of the resource must digitally sign and certify a particular resource. If the resource is not digitally signed, then the proxy service 215 can evaluate the claims and/or resource and can determine that the resource is not satisfactory based on the policy 225A.

If a resource and its corresponding claims satisfy the conditions outlined by the policy 225A, then the proxy service 215 can deliver the requested resource to the requesting consumer device. On the other hand, if the resource and its corresponding claims do not satisfy the conditions outlined by the policy 225A, then the proxy service 215 can send a notification to the requesting consumer device and can inform the client that the resource will not be delivered.

Optionally, the proxy service 215 can provide a message detailing reasons as to why the resource will not be delivered. For instance, the proxy service 215 can indicate which specific policy conditions were not satisfied or met by the resource and claims. In some cases, a particular resource can be quarantined or delayed from being delivered for a period of time until additional evidence or claims are acquired. Further details on these operations will be provided later.

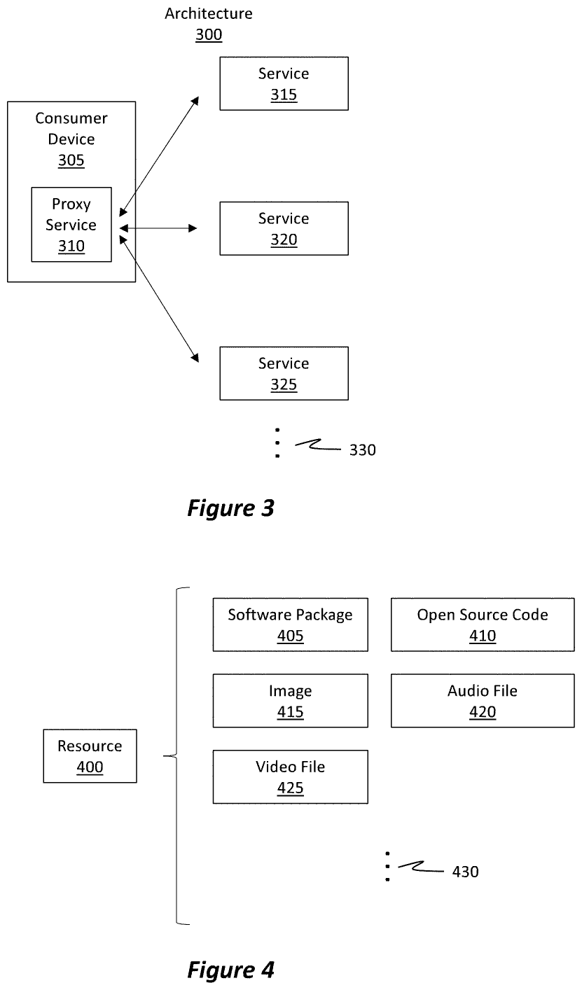

FIG. 3 shows an additional, or alternative, architecture 300 that includes a consumer device 305, which is representative of the consumer devices in FIG. 2. With this architecture 300, however, the consumer device 305 can be configured to locally include and execute a proxy service 310, which can operate in a similar manner as the behaviors and operations described in FIG. 2. For instance, the proxy service 310 can communicate with any number of services, such as service 315, 320, and 325. The ellipsis 330 illustrates how there may be any number of services. Accordingly, instead of residing in a cloud infrastructure, some embodiments provision the proxy service to reside locally on a consumer device.

### Resources & Metadata

Attention will now be directed to FIG. 4, which illustrates various implementations of a resource 400, which is representative of the resource 240A from FIG. 2. To illustrate, the resource 400 can include one or more of a software package 405 (e.g., comprising any number of libraries, dependencies, code, and so forth), open source code 410 (e.g., any type of code or routine), an image 415, an audio file 420, and/or a video file 425. The ellipsis 430 demonstrates how any other type of consumable data can also be considered as a resource 400. In this sense, any type of resource can be stored or provided by a provider service, and a consumer device can use the proxy service in an attempt to acquire the resource 400.

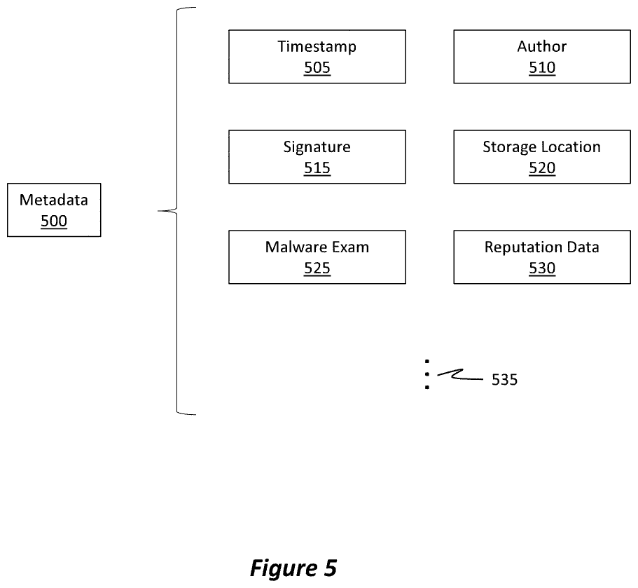

As mentioned previously, the proxy service 215 is able to acquire or import any type of claim or metadata (e.g., metadata 255 from FIG. 2) describing a resource. FIG. 5 describes some of the various different types of metadata 500 that can be imported by the proxy service, where this metadata 500 can be included in any of the claims mentioned previously (e.g., claims 260, 265, and 270 from FIG. 2).

Metadata 500 can optionally include timestamp 505 data describing a time when a resource was created, updated, versioned, modified, moved, stored, or any other time-based data describing any other type of event associated with a resource. Metadata 500 can include information about an author 510 (one or many authors) that generated a resource. Author 510 data can also include information about an organization to which the author belongs. Further details on this aspect will be provided later.

Metadata 500 can include signature 515 data or any other type of certification or authentication data. For instance, it may be the case that the resource is digitally signed by an entity so as to attest to certain safety measures the resource has or to attest to other characteristics the resource has.

Metadata 500 can include information about a storage location 520 where the resource is stored. This storage location 520 can also include information describing where other copies of the resource are located.

Metadata 500 can include information describing whether or not the resource has been subjected to a malware scan or exam, as shown by malware exam 525. The malware exam 525 can also list or include details regarding that scan. For instance, the malware exam 525 can describe any warnings or alerts that may have been generated as a result of performing the scan. The malware exam 525 can include an indication that there are no warnings or alerts as well.

Metadata 500 can include reputation data 530 describing any type of assertion made with reference to the resource. For instance, the reputation data 530 can refer to a reputation of the author who generated the resource and whether that author is a trusted entity. Similarly, the reputation data 530 can refer to a reputation of an organization to which the author belongs. The reputation data 530 can also refer to a reputation of an organization that is currently tasked with storing the resource. The reputation data 530 can also include information collected from any type of public or private forum where the resource is a topic of discussion. For instance, the proxy service can scan comments made in a forum and use natural language processing to determine whether the resource is viewed favorably or unfavorably. Additionally, or alternatively, a different service can be tasked with using natural language processing to perform this analysis, and the proxy service can receive results of the analysis from that other service in the form of a claim.

The ellipsis 535 demonstrates how any other type of information can be included in the metadata 500. In this sense, the metadata 500 can include any information that describes the state, status, and/or condition of a particular resource. This metadata 500 can be included in any claim. Furthermore, the metadata 500 can optionally come or originate from a same source as where the resource is located. Additionally, or alternatively, the metadata 500 can come or originate from a different source than where the resource is located. In some instances, some metadata can be imported from a first source, the resource is also imported from that first source, and some metadata can be imported from a second, different source.

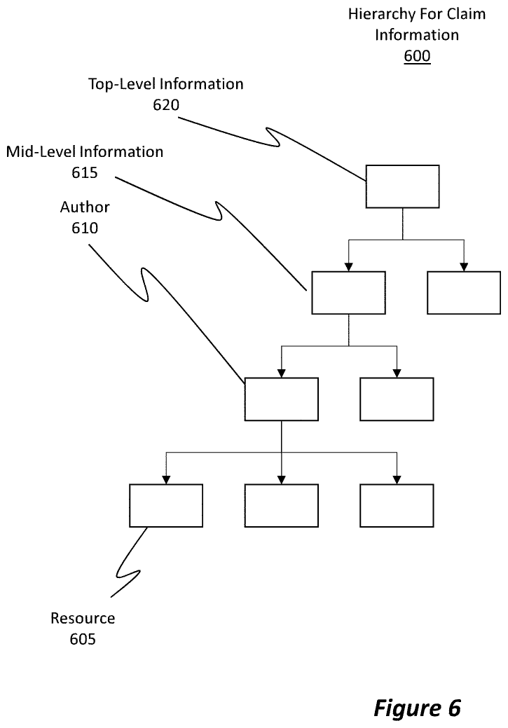

FIG. 6 further expands on some aspects of the metadata 500 of FIG. 5. FIG. 6 shows a hierarchy for claim information 600, which includes a resource 605 that is representative of the resources mentioned thus far. As mentioned earlier, the resource 605 is typically generated by an author 610. That author 610 might be involved or included within a particular group of developers in an organization. The mid-level information 615 can include information describing that group. That group is included within an overall enterprise, and the top-level information 620 can describe the overall enterprise. The metadata mentioned previously can include reputation data for each of these different stages or groupings. For instance, the metadata can include information specific to the resource 605, information specific to the author 610, the mid-level information 615 (i.e. information about the group), and the top-level information 620 (i.e. information about the enterprise). All of this metadata can be included in a claim that is imported to the proxy service. The proxy service can then perform an evaluation on that metadata to determine whether the underlying resource satisfies the thresholds and constraints outlined in the policy.

### Requests & Responses

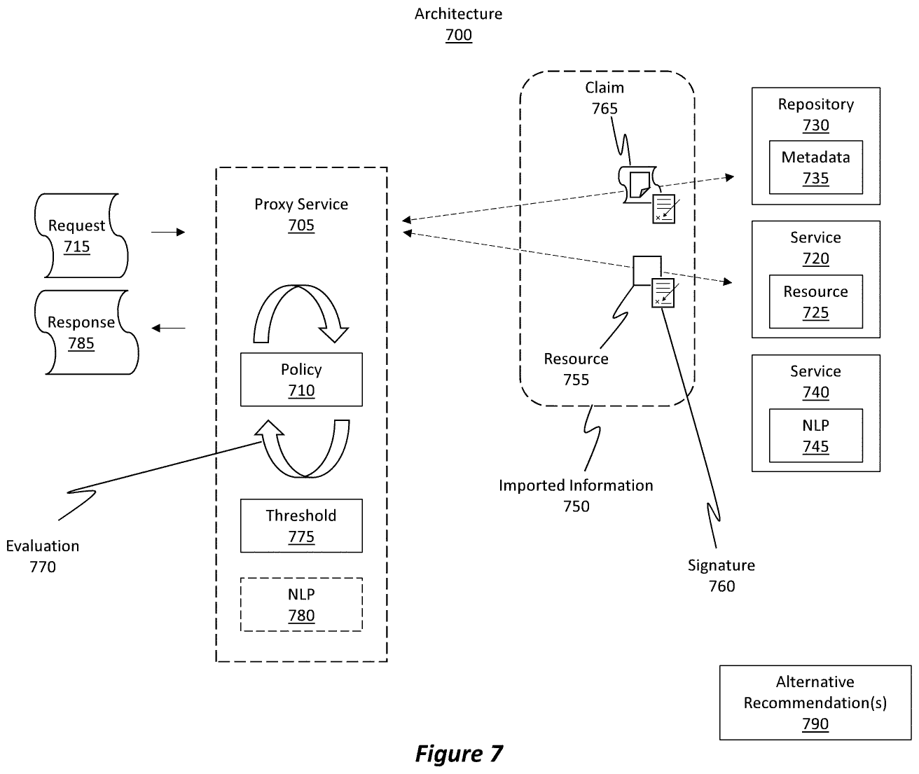

FIG. 7 shows an example architecture 700, which representative of the architecture 200 of FIG. 2. Architecture 700 includes a proxy service 705. The proxy service 705 receives policy 710 from a client such that the proxy service 705 is configured to implement the policy 710. The proxy service 705 receives a request 715 for a resource from a client device. In response to that request 715, the proxy service 705 is triggered to search for the resource as well as supplemental information about the resource.

In this scenario, the service 720 includes the requested resource 725. The repository 730 includes metadata 735 describing the resource 725. The service 740 includes a natural language processing NLP 745 engine designed to also identify reputation data describing the resource 725.

The proxy service 705 is able to query these various different services and repositories to import not only the resource 725 but also the metadata 735. Such information is considered imported information 750. For instance, the proxy service 705 receives a message comprising the resource 755 (i.e. the resource 725 from service 720). In some cases, the service 720 can digitally sign the message, as shown by signature 760 in an effort to enhance the veracity or authentication regarding the trustworthiness of the resource 755. Additionally, the proxy service 705 can receive a claim 765 comprising the metadata 735. The claim 765 can also be digitally signed, such as by the entity storing the metadata.

After receiving the resource 755 and/or the claim 765, the proxy service 705 can then begin to perform an evaluation 770 of the resource 755 and/or the claim 765 using the policy 710. In some scenarios, this evaluation 770 is performed on the resource 755 separately from the claim 765. That is, a first evaluation is performed on the resource 755 by itself, and a second evaluation is performed on the claim 765 by itself In some cases, the evaluation considers both the resource 755 and the claim 765 together. In some cases, the evaluation is ongoing as new information is continuously, periodically, or asynchronously acquired over time.

In any event, the proxy service 705 considers the imported information 750 to determine whether the imported information 750 satisfies one or more policy thresholds, as outlined by threshold 775. Such thresholds can include security thresholds (e.g., was a malware scan performed, are there any warnings associated with the resource, are there any alerts associated with the resource, are there any viruses associated with the resource, is the resource considered safe, and so on). Such thresholds can also include reputation-based thresholds (e.g., is the reputation of the author, group, or enterprise considered trustworthy or not trustworthy, how long have the entities been in existence, how long has the resource been in existence, how many downloads has the resource been subjected to, how widespread is the usage of the resource, etc.). Any other threshold can be specified by the policy 710.

In some cases, the proxy service 705 can include an NLP 780 engine that can additionally acquire reputation data describing the resource and consider that reputation data during the evaluation 770. In some embodiments, the proxy service 705 itself refrains from operating an NLP engine and instead relies on an external NLP engine to acquire and analyze reputation data, such as the NLP 745 in the service 740.

In response to performing the evaluation 770, the proxy service 705 generates a response 785 that is sent back to the requesting client device. The response 785 can include a plethora of information. In one scenario, the response 785 can include the requested resource (e.g., resource 755). Including the resource 755 in the response 785 provides an implicit indication to the client device that the resource 755 adequately satisfied the constraints outlined in the policy 710. Stated differently, in this scenario, the resource 755 and the metadata 735 “passed” the tests performed based on the policy 710.

In another scenario, the response 785 can include a qualified permission. Here, the qualified permission can include the resource as well as additional data describing conditions associated with the resource. For instance, the response 785 might include warnings associated with the resource. Additionally, or alternatively, the response 785 might provide a modified version of the resource, where the resource is modified to include an audit log in order to enable the client to track how the resource is used.

In another scenario, the response 785 can include an indication that the resource 755 has temporarily been placed in quarantine and will not yet be provided to the client device. One reason for quarantining the resource 755 is because it might be the case that a sufficient amount of claims and/or metadata has not yet been gathered or imported, so the evaluation 770 cannot be performed to completion. By placing the resource in quarantine, the proxy service 705 is afforded additional time in which to collect information to make an informed evaluation. Often, the time duration for quarantine is about 6 hours (e.g., in scenarios specific to software packages), though other time periods can be used. Other resources might have different quarantine durations.

In some scenarios, the response 785 can include an indication that the resource will not be provided to the client (i.e. a denial). The response 785 can then also include messages or notifications indicating reasons as to why the request 715 was denied. For instance, the messages can outline that perhaps the resource failed to satisfy certain constraints or conditions included in the policy 710, and those specific conditions can be identified in the response 785.

In some scenarios, particularly when a resource is denied, the proxy service 705 can include one or more alternative recommendation(s) 790 in the response 785. Such alternative recommendation(s) 790 can include a replacement or substitute for the requested resource, where that substitute is designed to operate in a similar manner as the originally requested resource. As an example, if the requested resource is a software package, but that specific software package failed the policy evaluation, then an alternative software package, which operates in a similar manner, can be identified and submitted for considered by the client. Here, the alternative software package can also be evaluated by the proxy service 705 to ensure that the alternative satisfies the constraints outlined by the policy 710.

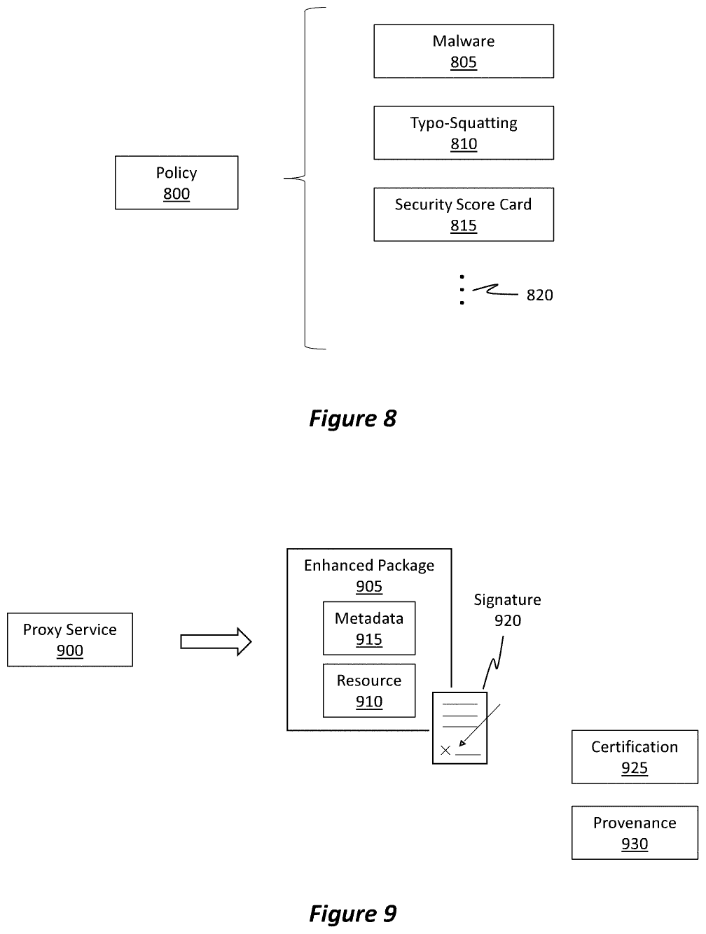

The proxy service 705 can implement any type of policy. FIG. 8 illustrates some example types of policy that can be implemented by the proxy service 705. To illustrate, FIG. 8 shows policy 800, which is representative of the policy 710 from FIG. 7.

As examples only, the policy 800 can include conditions, requirements, or constraints related to malware 805, typo-squatting 810, and/or security score card 815. The ellipsis 820 demonstrates how the policy 800 can include any other type of conditions or requirements.

Regarding the malware 805, the policy 800 can be designed to restrict or limit resources that have certain types of warnings or alerts based on a malware or virus scan performed on the resource. The policy 800 can be designed to restrict or limit resources that have a threshold number of warnings or alerts based on scans performed on the resource.

The policy 800 can also include conditions to avoid typo-squatting 810. Typo-squatting 810 refers to a technique for hacking a uniform resource locator (URL). For instance, a character in a particular URL can be slightly modified to look like the original character in order to fool an unsuspecting entity. If this incorrect URL is entered into a browser, a user will be directed to a fake website and may potentially divulge personal information, such as perhaps banking information. The policy 800 can be configured to help detect and avoid scenarios involving typo-squatting.

The policy 800 can also include techniques related to a security score card 815. Generally, a security score card 815 refers to a tool that can be executed against a data file (e.g., perhaps source code) to evaluate how secure or safe that file is against possible threats. A score can be generated. The policy 800 can be configured to potentially require a certain score to meet or exceed a minimum threshold score in order for the resource to be delivered to a client.

The embodiments can be configured to implement any other type of policy, condition, or requirement, without limit. Indeed, policy related to security, storage, access, users, cost, reputation, timing, and so forth can be implemented.

### Enhanced Packages

FIG. 9 shows how the proxy service 900, which is representative of the proxy services mentioned thus far, can generate an enhanced package 905 and can transmit that enhanced package 905 as the response 785 from FIG. 7. Here, the enhanced package 905 can include the resource 910 that was requested by the client device. In addition to that resource 910, the enhanced package 905 can also include some or potentially all of any metadata 915 that was collected for the resource 910. In some cases, the metadata 915 can be integrated into the resource 910. For instance, if the resource 910 is source code, the metadata 915 can be included in the source code as commented (i.e. non-executable) statements. In some cases, the metadata 915 can be included in a header of the resource 910. In some cases, the metadata 915 is not directly integrated into the resource 910 but rather is linked or associated with the resource 910 in some manner. By being included in the same enhanced package 905 as the resource 910, the metadata 915 is considered to be linked or associated with the resource 910 even though the metadata 915 might reside in a separate file or container than the resource 910.

Optionally, the proxy service 900 can digitally sign the resource 910 and/or the metadata 915 and/or the entire enhanced package 905, as shown by signature 920. The signature 920 can operate as an indicator to the client device that the information the proxy service 900 is transmitting is considered trustworthy and has been reviewed by the proxy service 900. Each instantiation of the proxy service 900 can optionally include its own corresponding signature 920. Client devices can be associated with a particular instance of a proxy service 900. By receiving data signed by that corresponding proxy service instance, the client device can be assured that it is receiving trustworthy information. In this sense, the signature 920 operates as a certification 925 of authenticity or authentication.

In some cases, the enhanced package 905 can also include a provenance 930 for the resource 910. The provenance 930 indicates an origination location and/or a storage location for the resource 910. The provenance 930 can be included in the metadata 915.

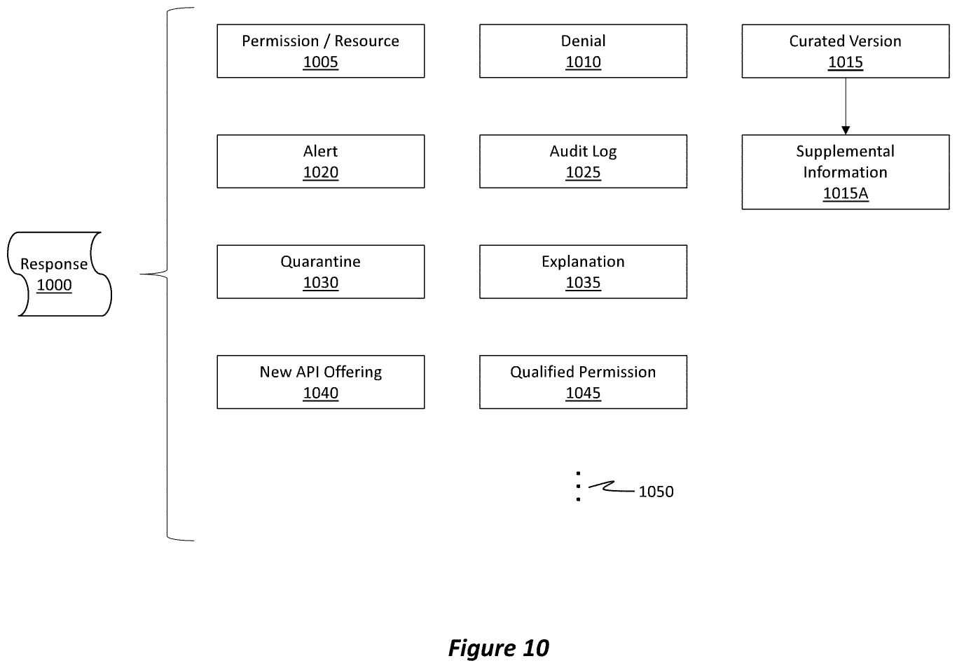

FIG. 10 lists some other information that can be included in a response 1000, which is representative of the response 785 from FIG. 7 and which may be in the form of an enhanced package 905 of FIG. 9. In some implementations, the response 1000 can include a permission/resource 1005 indication, where this indication informs the client device that it is permitted to use the requested resource. In some cases, the response 1000 also includes the actual resource. In some cases, transmission of the resource itself operates as implicit permission indicator, as described earlier.

The response 1000 can also include a denial 1010. Denial 1010 indicates that the requested resource will not be delivered to the client device.

In some cases, the response 1000 can include a curated version 1015 of the resource. The curated version 1015 of the resource can include supplemental information 1015A, such as metadata, about the resource, as described earlier. Here, the curated version 1015 is designed in a manner to cause the client device to operate as if it were communicating directly with the provider service as opposed to a proxy service. That is, there is no need to modify or further configure the client device; instead, the proxy service can be configured to appear as though it is a provider service to the client device. In this sense, the behavior of the client device need not change. The curated version 1015 can thus provide a requested version of a resource and potentially describe the behavior of that resource using the supplemental information 1015A.

In some cases, the response 1000 can include an alert 1020 describing various conditions associated with a resource. For instance, the alert 1020 can include the details of a malware scan performed on the resource. The alert 1020 can include details about a reputation of the resource or an entity associated with the resource. The alert 1020 can include details about a storage location of the resource. Indeed, any type of alert can be provided.

In some implementations, the response 1000 can include an audit log 1025 or, alternatively, the administrator of the proxy service would be able to use the audit log to understand what is flowing through the proxy (i.e. in one scenario, the proxy can be the provider of the audit log). The audit log can be delivered or accessed separately from the response and/or the resource. The audit log 1025 can identity which entities the proxy service communicated with to acquire the resource and the information describing the resource. In some cases, an audit log can be linked or associated with a resource such that the audit log follows the resource. As the resource is used, the audit log can be updated to indicate which client devices or entities are using the resource. This audit log enables the system to track and monitor the resource.

In some embodiments, the response 1000 includes an indication that the resource is temporarily placed in a quarantine, as shown by quarantine 1030. The quarantine 1030 indication can state how long the resource will be quarantined and potentially where the resource is quarantined.

The response 1000 can include explanation 1035 data that is provided to further explain any conditions or states that have been detected by the proxy service with regards to the resource. Any data can be included in the explanation 1035.

In some cases, the proxy service can offer a new API that is potentially known only to that proxy service and/or to clients that would know how to use the tool (e.g., developer tools). This API tool can be provided to a client device to provide additional information about resources to the client, as shown by new API offering 1040.

In some cases, the response 1000 includes a qualified permission 1045, where the resource is provided to a client device but where potential constraints or restrictions might be placed on that resource. For instance, it may be the case that a resource can be used only when a VPN is established while using the resource. It may be the case that a resource can be used only if a subsequent or perhaps periodic malware or antivirus scan is performed on the resource once the resource is downloaded onto a client device. In this sense, additional policy can be associated or perhaps inserted into the resource, and that additional policy can optionally control a subsequent use or behavior of the resource after it has been downloaded onto a client device.

Other information can be included in the response 1000, without limit. Indeed, the ellipsis 1050 demonstrates how the response 1000 should be interpreted broadly.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

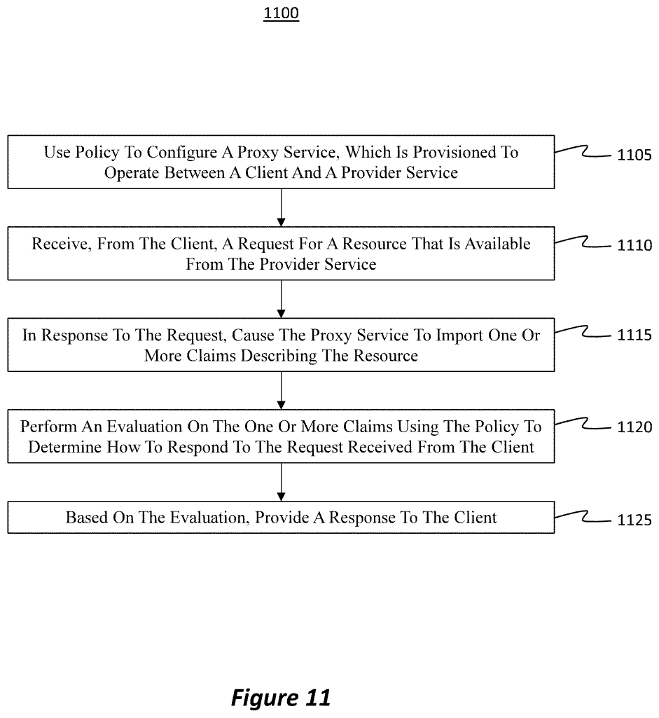

Attention will now be directed to FIG. 11, which illustrates a flowchart of an example method 1100 for operating a proxy service that imports information about one or more resources and for determining how to handle the one or more resources. Method 1100 can be implemented by a computer system, which will be described later. Further, method 1100 can be implemented within any of the architectures mentioned earlier, such as architecture 200 from FIG. 2 and architecture 700 from FIG. 7. The proxy services mentioned herein can be configured to perform method 1100.

Method 1100 includes an act (act 1105) of using policy to configure the proxy service (e.g., proxy service 215 from FIG. 2), which is provisioned to operate between the client (e.g., consumer device 205A) and a provider service (e.g., provider service 235A). Act 1110 involves receiving, from the client, a request (e.g., request 715 from FIG. 7) for a resource (e.g., resource 725) that is available from the provider service. In some cases, the resource is a software package that is available from the provider service. In some cases, the resource is any one or combination of an image, an audio file, or even a video file that is available from the provider service.

In response to the request, act 1115 involves causing the proxy service to import one or more claims describing the resource. To illustrate, FIG. 2 shows how the proxy service 215 is importing claims 260, 265, and 270 from the various repositories and services. The claims include metadata describing the resource. Optionally, the metadata includes one or more of a creation timestamp for the resource, an author of the resource, a signature authentication for the resource, a storage location for the resource, an indication whether a malware exam has been performed on the resource, or reputation data regarding an organization that is associated with the resource. In some cases, the claims include at least one claim that is received from a source that is different from the provider service.

In act 1120, the proxy service performs an evaluation (e.g., evaluation 770 from FIG. 7) on the one or more claims using the policy to determine how to respond to the request received from the client (e.g., perhaps to check whether the resource has been subjected to typo-squatting or a malware check or any other consideration). Based on the evaluation, act 1125 involves the proxy service providing a response (e.g., response 785 from FIG. 7) to the client. The response provided to the client can include one or more of a permission for the resource to be delivered to the client, a denial for the resource to be delivered to the client, an indication that the resource is being held in quarantine, or qualified permission for the resource to be delivered to the client, where the qualified permission includes one or more indicators regarding a status of the resource (e.g., perhaps alerts or warnings associated with the resource).

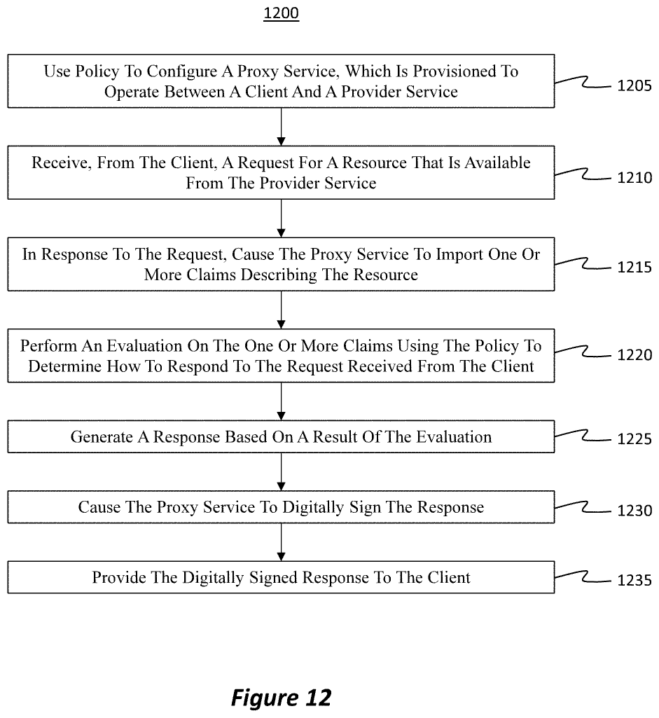

FIG. 12 describes another method 1200 for operating a proxy service that imports information about one or more resources and for determining how to handle the one or more resources. Method 1200 can also be performed within the disclosed architectures and by the disclosed proxy services. Initially, act 1205 includes using policy to configure the proxy service, which is provisioned to operate between a client and a provider service. The policy is typically received from the client such that the policy is client-driven policy. Act 1210 includes receiving, from the client, a request for a resource that is available from the provider service.

In response to the request, act 1215 includes causing the proxy service to import one or more claims describing the resource. An evaluation is then performed (act 1220) on the one or more claims using the policy to determine how to respond to the request received from the client.

Act 1225 includes generating a response based on a result of the evaluation. Notably, the response can be configured to include at least one of the resource, or a denial indicating that the resource will not be delivered to the client, or an indication that the resource is being held in quarantine, or a qualified version of the resource. The qualified version of the resource includes the resource and one or more indicators describing a status of the resource (e.g., alerts raised, warnings, etc.).

Act 1230 involves causing the proxy service to digitally sign the response. Act 1235 then includes providing the digitally signed response to the client. By causing the proxy service to digitally sign the response, the receiving client device can have assurance that the response is valid and trustworthy.

In some implementations, the claims can include a security score card for the resource, where the security score card includes a score quantifying how secure the resource is. In some cases, the score will be required to meet or exceed a particular threshold (defined by the policy) in order for the resource to be delivered to the client. In some cases, the response can include an indication that the resource is being held in quarantine, and the resource can be held in quarantine for a determined time period (e.g., 1 hour, 2 hours, 3 hours, 4 hours, 5 hours, 6 hours, or any other time period). Furthermore, the process of performing the evaluation on the claims using the policy can include determining whether the resource satisfies a predetermined security threshold. If the determination indicates that the threshold is satisfied, then the resource can be delivered to the client device.

In some cases, the client is an enterprise that includes multiple client devices. The proxy service can service the multiple client devices by providing the resource to at least one of those devices. Additionally, it may be the case that the policy is received from the enterprise and thus is enterprise-wide policy. In some cases, a group within the enterprise can submit the policy, thereby causing the policy to be group-specific. Different groups within the enterprise can submit different policies. The policies can be used to configure different instantiations of the proxy service.

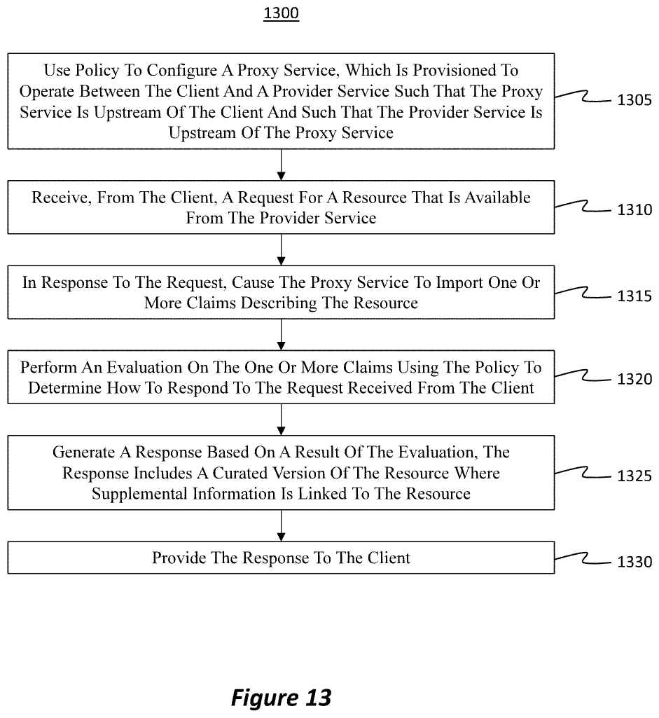

FIG. 13 describes another example method 1300, which can be implemented by the disclosed proxy service in the disclosed architectures. Act 1305 involves using policy to configure the proxy service, which is provisioned to operate between a client and a provider service. As a consequence, the proxy service is upstream of the client, and the provider service is upstream of the proxy service. Act 1310 includes receiving, from the client, a request for a resource that is available from the provider service. In response to the request, act 1315 includes causing the proxy service to import one or more claims describing the resource.

Act 1320 includes performing an evaluation on the one or more claims using the policy to determine how to respond to the request received from the client. Act 1325 comprises generating a response based on a result of the evaluation. The response includes a curated version of the resource in which supplemental information is linked to the resource. Act 1330 then includes providing the response to the client. Optionally, the supplemental information can include at least one of the claims. In some cases, such as where the resource is an open source package, the claims can include a source code provenance for the resource.

Accordingly, by following the disclosed principles, significant benefits and advantages can be realized, including improvements over firewalls and antivirus software. The embodiments improve computer security and also improve the quality of data that is delivered to a client device. It should also be noted that the terms “involving” and “having” (and their variants) should be interpreted in an open manner, similar to how “including” or “comprising” are interpreted.

### Example Computer/Computer Systems

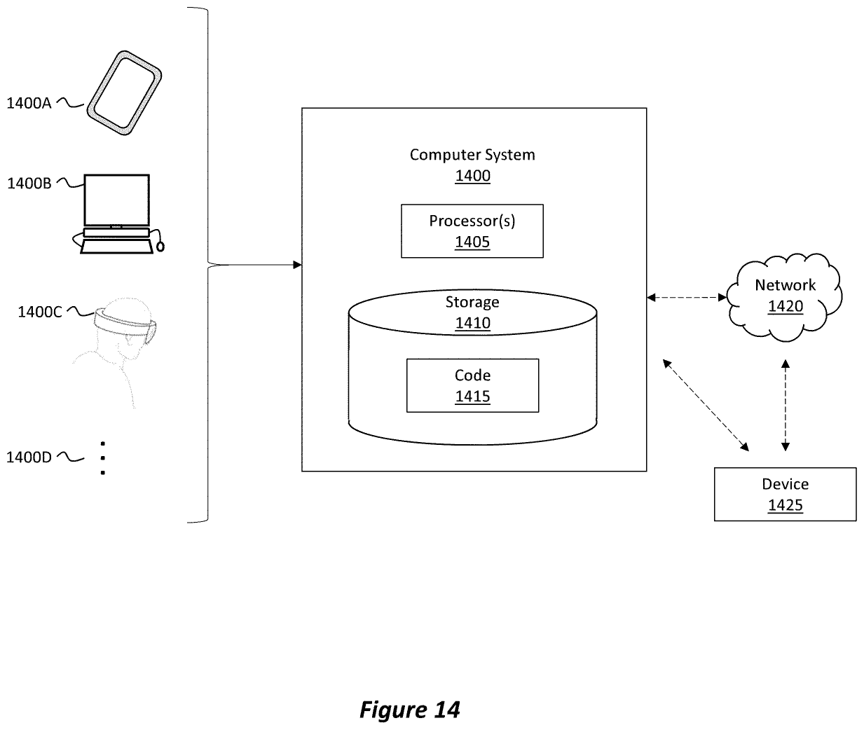

Attention will now be directed to FIG. 14 which illustrates an example computer system 1400 that may include and/or be used to perform any of the operations described herein. Computer system 1400 may take various different forms. For example, computer system 1400 may be embodied as a tablet 1400A, a desktop or a laptop 1400B, a wearable device 1400C, mobile device, or a standalone device, or any other type of device, as shown by the ellipsis 1400D. Computer system 1400 may also be a distributed system that includes one or more connected computing components/devices that are in communication with computer system 1400.

In its most basic configuration, computer system 1400 includes various different components. FIG. 14 shows that computer system 1400 includes one or more processor(s) 1405 (aka a “hardware processing unit”) and storage 1410.

Regarding the processor(s) 1405, it will be appreciated that the functionality described herein can be performed, at least in part, by one or more hardware logic components (e.g., the processor(s) 1405). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “engine,” or “service” can refer to hardware processing units or to software objects, routines, or methods that may be executed on computer system 1400. The different components, modules, engines, and services described herein may be implemented as objects or processors that execute on computer system 1400 (e.g. as separate threads).

Storage 1410 may be physical system memory, which may be volatile, non-volatile, or some combination of the two. The term “memory” may also be used herein to refer to non-volatile mass storage such as physical storage media. If computer system 1400 is distributed, the processing, memory, and/or storage capability may be distributed as well.

Storage 1410 is shown as including executable instructions (i.e. code 1415). The executable instructions represent instructions that are executable by the processor(s) 1405 of computer system 1400 to perform the disclosed operations, such as those described in the various methods.

The disclosed embodiments may comprise or utilize a special-purpose or general-purpose computer including computer hardware, such as, for example, one or more processors (such as processor(s) 1405) and system memory (such as storage 1410), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1400 may also be connected (via a wired or wireless connection) to external sensors (e.g., one or more remote cameras) or devices via a network 1420. For example, computer system 1400 can communicate with any number devices (e.g., device 1425, such as a client device or a device hosting a provider service) or cloud services to obtain or process data. In some cases, network 1420 may itself be a cloud network. Furthermore, computer system 1400 may also be connected through one or more wired or wireless networks to remote/separate computer systems(s) that are configured to perform any of the processing described with regard to computer system 1400.

A “network,” like network 1420, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1400 will include one or more communication channels that are used to communicate with the network 1420. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system configured to operate a proxy service that imports information about one or more resources and that determines how to handle the one or more resources, said computer system comprising:
one or more processors; and
one or more hardware storage devices that store instructions that are executable by the one or more processors to cause the computer system to:
use policy to configure the proxy service, which is provisioned to operate between a client device and a provider service;
receive, from the client device, a request for a resource that is available from the provider service;
in response to the request, cause the proxy service to import one or more claims describing the resource;
perform an evaluation on the one or more claims using the policy to determine how to respond to the request received from the client device; and
based on the evaluation, provide a response to the client device.

2. The computer system of claim 1, wherein the resource is a software package that is available from the provider service.

3. The computer system of claim 1, wherein the resource is an image that is available from the provider service.

4. The computer system of claim 1, wherein the resource is an audio file that is available from the provider service.

5. The computer system of claim 1, wherein the resource is a video file that is available from the provider service.

6. The computer system of claim 1, wherein the one or more claims include metadata describing the resource.

7. The computer system of claim 6, wherein the metadata includes one or more of:
a creation timestamp for the resource,
an author of the resource,
a signature authentication for the resource,
a storage location for the resource,
an indication whether a malware exam has been performed on the resource, or
reputation data regarding an organization that is associated with the resource.

8. The computer system of claim 1, wherein the one or more claims include at least one claim that is received from a source that is different from the provider service.

9. The computer system of claim 1, wherein the response provided to the client device includes one of:
permission for the resource to be delivered to the client device;
denial for the resource to be delivered to the client device;
an indication that the resource is being held in quarantine; or
qualified permission for the resource to be delivered to the client device, wherein the qualified permission includes one or more indicators regarding a status of the resource.

10. The computer system of claim 1, wherein the policy checks whether the resource has been subjected to typo-squatting.

11. A method for operating a proxy service that imports information about one or more resources and for determining how to handle the one or more resources, said method comprising:
using policy to configure the proxy service, which is provisioned to operate between a client and a provider service;
receiving, from the client, a request for a resource that is available from the provider service;
in response to the request, causing the proxy service to import one or more claims describing the resource;
performing an evaluation on the one or more claims using the policy to determine how to respond to the request received from the client;
generating a response based on a result of the evaluation, wherein the response includes at least one of:
the resource, or
a denial indicating that the resource will not be delivered to the client, or
an indication that the resource is being held in quarantine, or
a qualified version of the resource, wherein the qualified version of the resource includes the resource and one or more indicators describing a status of the resource;
causing the proxy service to digitally sign the response; and
providing the digitally signed response to the client.

12. The method of claim 11, wherein the one or more claims include a security score card for the resource.

13. The method of claim 11, wherein the response includes an indication that the resource is being held in quarantine, and wherein the resource is held in quarantine for a determined time period.

14. The method of claim 11, wherein performing the evaluation on the one or more claims using the policy includes determining whether the resource satisfies a predetermined security threshold.

15. The method of claim 11, wherein the policy is received from the client such that the policy is client-driven policy.

16. The method of claim 11, wherein:
the client is an enterprise comprising multiple client devices,
the proxy service services the multiple client devices by providing the resource to at least one client device included among the multiple client devices, and
the policy is received from the enterprise.

17. A method for operating a proxy service that imports information about one or more resources and for determining how to handle the one or more resources, said method comprising:
using policy to configure the proxy service, which is provisioned to operate between a client and a provider service such that the proxy service is upstream of the client and such that the provider service is upstream of the proxy service;
receiving, from the client, a request for a resource that is available from the provider service;
in response to the request, causing the proxy service to import one or more claims describing the resource;
performing an evaluation on the one or more claims using the policy to determine how to respond to the request received from the client;
generating a response based on a result of the evaluation, wherein the response includes a curated version of the resource where supplemental information is linked to the resource; and
providing the response to the client.

18. The method of claim 17, wherein the supplemental information includes at least one of the one or more claims.

19. The method of claim 17, wherein the resource is an open source software package.

20. The method of claim 17, wherein the one or more claims includes a source code provenance for the resource.
